(19) United States
(12) Patent Application Publication
(10) Pub. No.: US 2025/0171362 A1
(43) Pub. Date: May 29, 2025

(54) A METHOD FOR MANUFACTURING A CERAMIC TILE AND AN EQUIPMENT FOR MANUFACTURING A CERAMIC TILE.

(71) Applicant: MARAZZI GROUP SRL, Sassuolo (IT)

(72) Inventor: Daniele PAGANELLI, Modena (IT)

(21) Appl. No.: 18/844,174

(22) PCT Filed: Mar. 3, 2023
(86) PCT No.: PCT/IB2023/051990

§ 371 Date: Sep. 5, 2024

(30) Foreign Application Priority Data
Mar. 7, 2022 (EP) 22160582.7

(51) Int. Cl. C04B 33/34; B28B 11/24; C04B 33/24; F27B 9/40; G01B 11/24

(52) U.S. Cl. CPC C04B 33/34; B28B 11/243; C04B 33/24; F27B 9/40; G01B 11/24; C04B 2235/656

(57) ABSTRACT

A method for manufacturing a ceramic tile and an equipment for manufacturing a ceramic tile. A method for manufacturing ceramic tiles (3) that comprises the steps of providing a green tile (2) formed by a mixture of ceramic raw materials, firing said green tile (2) in a kiln (1) to obtain a ceramic tile (3), said kiln (1) being configured to fire the green tile (2) according to a firing cycle defined by one or more firing parameter (HR, MFT, UICR, UIICR, UIIICR, LICR, LIICR, LIIICR), characterized int that it comprises the steps of measuring a shape and/or dimension parameter of the obtained ceramic tile (3), and the step of adjusting the firing parameter on the basis of said measurement, preferably while one parameter is adjustable the remaining parameters are be kept constant.

The present invention relates to a method for manufacturing a ceramic tile, in particular a floor, wall, ceiling or furniture tile, and to an equipment for manufacturing a floor tile.

Ceramic tiles are manufactured via firing at high temperature, in continuous roller kiln, of a green tile comprising ceramic raw materials in form of compacted powders. During firing said powders are sintered to consolidate the ceramic material and reduce the residual porosity thereof. The high degree of sintering, especially in low porous materials like porcelain, causes a relevant shrinkage of the tile that, if not well balanced, can lead to dimensional and/or shape deformations in the final product.

Usually, in private practice, said deformations are corrected by intervening on one or more process parameters, not necessarily belonging to the firing process, like for example pressing conditions of the powders, firing temperatures, change of materials etc. Said correction are always done manually and are based on the experience of the operator so that they are approximated and can become effective only after several trials and after the production of scraps and/or of second choice material.

Moreover, the measurement of said deformation is made only on selected samples and, since the tiles are hot at the exit of the kiln, is often delayed to the moment when the operator can handle the sample for the measurement, so that the resulting measured deformation doesn't precisely reflect the real deformation of the product.

The present invention aims in the first place to provide an alternative method for manufacturing ceramic tile, which, in accordance with several of its preferred embodiments, is directed to solve one or more of the problems arising in the state of the art.

Thereto, the present invention, according to its first independent aspect, relates to a method for manufacturing ceramic tiles that comprises the steps of providing a green tile formed by a mixture of ceramic raw materials, firing said green tile in a kiln to obtain a ceramic tile, said kiln being configured to fire the green tile according to a firing cycle defined by one or more firing parameter. The method of the invention has the characteristic that it comprises the steps of measuring a shape and/or dimension parameter of the obtained ceramic tile, and the step of adjusting the firing parameter on the basis of said measurement. Thanks to said adjustment, the efficacy of the manufacturing process can be improved.

Preferably, while one parameter is adjustable, the remaining parameters can be kept constant (are not adjusted). In this way, it is possible to minimize interaction of multiple parameters and the adjustment is more effective.

Said firing parameters can comprise maximum temperature, heating rate, cooling rate, firing time. In the most preferred embodiment, said adjustable firing parameter comprises the cooling rate. The inventor has found that, by acting on the cooling rate of the firing process, it is possible to improve the efficacy of the correction since the risk influence of further factors is minimized.

It is noted that, in the most preferred embodiment, said firing cycle comprise an upper firing cycle, acting on an upper surface of the tile, and a lower firing cycle, acting on a lower surface of the tile. Said upper and lower firing cycles are defined by respective upper and lower firing parameters. Said upper and lower firing cycle can be identical or differ each other in one or more firing parameters. Preferably, said adjustable firing parameters can be both or only one of the upper and lower correspondent firing parameters, for example upper and lower cooling rate.

It is also noted that the firing cycle comprises a heating stage and a cooling stage. Said cooling stage comprises one or more parts, preferably two, even more preferably three cooling parts. In particular, the first cooling part starts from the maximum temperature of the firing cycle, for example above 900° C., preferably between 900° C. and 1250° C., and ends at a temperature around 800° C., for example between 750° C. and 850° C. In case the final ceramic tile comprises a glassy phase, as it will also be explained below, said first cooling part can preferably end at a temperature preferably slightly below, the glass transition temperature of said glassy phase. For example, said first cooling part can end at a temperature being 50° C. more or 50° C. less than said glass transition temperature. The second cooling part starts from the end of the first cooling part and ends at a temperature around 570° C., in particular said end temperature of the second period substantially corresponds to the transition temperature between β-quartz and α-quartz. The third cooling part starts from the end of the second cooling part and ends at the exit of the kiln, for example at a temperature around 150° C. Each of the first, second and third cooling part comprises a respective first, second and third cooling rate. Preferably, each cooling part comprises a respective upper and lower cooling rate, just by way of example the first cooling part comprises an upper and a lower first cooling rate. It is noted that the second cooling part shows a cooling rate that is generally lower than in the first and second cooling part. This due to the fact that an uncomplete transformation of the quartz from β-quartz to α-quartz could lead to fractures in the tile. Preferably, according to some embodiments of the invention, the cooling rate is adjusted in the first and/or in the second cooling rate for correcting said deformation.

Preferably, said cooling can be either direct or indirect. In case of direct cooling cool air (air at a lower temperature of the tile) can be blown directly on the upper and lower surface of the tile; in case of indirect cooling said fresh air is blown in tubes disposed below and above the tile, in such a way that the cooling is slower than in the direct cooling. Preferably, cooling is direct in the first and/or second cooling part. Preferably, cooling is indirect in the third cooling part. Preferably said cooling rate is adjusted by varying the flow condition, for example flow rate, temperature, speed, of the fresh air, either in the indirect or direct cooling.

The shape and/or dimension parameter can be preferably measured by a measuring device connected to a control unit. Said control unit can preferably be connected to the kiln for adjusting said firing parameter. In this way the firing parameters can be adjusted immediately after said measurement so that production of scrap of second choice material can be minimized. Moreover, said adjustment can be based on a plurality of shape and/or dimension parameter measured on a same tile or on multiple tiles so that said measurement and the consequent adjustment is more accurate. Preferably said measuring device comprises optical sensor. The inventor has found that by using optical sensor the measuring can be quicker and also more accurate that by using contact sensor. In this way the measurement can be performed immediately after the exit of the kiln so that production of scrap or second choice material limited to the material in the cooling part of the kiln.

In some embodiments, said deformation can be measured immediately at the exit of the kiln. In alternative embodiments, said deformation can be measured after a predetermined time after the exit of the tile from the kiln, said predetermined time preferably being at least 10 min, for example at least 20 min. For example, said deformation can be measured when the temperature of the tile is below a predetermined threshold temperature, said threshold temperature preferably 150° C., for example below 100° C. In this way, it may be possible to prevent influence of the temperature of the tile on the optical measuring, moreover after said predetermined time, the tile is stabilized, and the deformation becomes definitive.

In the preferred embodiment, the measuring device comprises a device configured to measure the planarity deviation of the tile. The planarity deviation is the deviation, with respect to the flat surface, of the center of the tile. In practice, a non-planar tile can be either concave or convex; if it's concave, the tile shows an upward concavity and the center of the tile stays on a lower plane than the corners; if it's convex, the tile shows a downward concavity, and the center of the tile stays on an upper plane than the corners. The inventor, during private research has found that the planarity deviation can be caused by several factors of the whole manufacturing process of the tile including, for example, pressing condition, firing conditions, both during heating or cooling, composition of the green tile.

During private research the inventor has found that said planarity deviation can be corrected by adjusting the cooling rate, in particular by acting on the upper and/or lower cooling rate. More in detail, the inventor has found that in case the measured planarity deviation shows a concave tile, said deviation can be corrected by increasing the upper cooling rate. The inventor has also found that in case the measured planarity deviation shows a convex tile, said deviation can be corrected by increasing the lower cooling rate. During said private research, the inventor has found that the cooling rate influences the final volume of the tile. To a higher cooling rate, corresponds a higher volume. Therefore, if the tile tends to be concave, by increasing the cooling the upper cooling rate, the volume of the upper part of the tile will be higher than the lower one so that the deformation that causes the concavity can be compensated. It is noted that by acting on the upper and/or cooling rate it may be possible to correct planarity deviations caused by upstream factors of the process like, for example, pressing condition without intervening on said upstream factors themselves.

Therefore, the correction of the planarity can be performed in an easy way without the need of intervening on multiple factors that could cause other deformation.

During internal observation the inventor has found that the tiles obtained in standard processes have the tendency to be convex rather than concave. The inventor has observed that said planarity deformation can be due to the fact that cooling can be more efficient, and thus the cooling rate higher, on the upper surface of the tile. This may be due to a sort of thermal shield effect caused by the presence of the roller and by the difficulty of blowing fresh air upward in a hot environment. Therefore, in the most preferred embodiment, said adjustment of the cooling rate is performed especially, or even exclusively, on the upper cooling rate. This preferred embodiment a convex planarity deviation can be adjusted by lowering down the upper cooling rate. On the other hand, a concave planarity deviation can be adjusted by increasing the upper cooling rate.

Preferably the tile comprises a support made of a ceramic material, for example porcelain, red body tile, earthenware, single fire wall tile. The tile can further comprise a top layer comprising one or more glaze layers. In the most preferred embodiment, the support is made of porcelain and preferably comprises one or more glaze layers on the upper surface.

In the preferred embodiment the support layer, of the fired tile, can comprise a glassy phase. Preferably said glassy phase is at least partially formed during the firing process. Said glassy phase can represent up to the 80%, for example between 50 and 75% based on the total weight of the support. The inventor has found that it is particularly the glassy phase of the ceramic tile that shows the tendency to vary the volume according to the cooling rate, thereto in presence of a high quantity of glassy phase the adjustment of the cooling rate is more effective in contrasting the planarity deviation for ceramic material having a higher content of glassy phase. To this aim the effect of the cooling rate adjustment is particularly effective in case of tiles having one more glaze layer on the upper surface since said glazes are mostly or completely made of vitreous material.

The inventor has also found that the adjustment of the cooling temperature becomes particularly effective in in contrasting the planarity deviation when the cooling rate is modified around the glass transition temperature of the glassy phase. In some embodiments, said firing parameter can be adjusted on the basis of said measurement and on the basis of said glass transition temperature. In some embodiment of the invention said cooling rate can be adjusted when the temperature of the tile is in a range between 50° C. more and 50° C. less than the glass transition temperature of the glassy phase, for example between 750° C. and 850° C. In fact, the inventor has surprisingly found that final volume of the tile changes when the cooling rate is changed in proximity of the glass transition temperature of the glassy phase. To this aim the cooling rate can be adjusted across the transition between the first and the second cooling part of the firing cycle. Preferably the cooling rate can be adjusted only in a limited portion of the first and/or of the second cooling part of the firing cycle.

The method may conveniently comprise the step of determining the glass transition temperature of the mixture of raw materials of the green tile, i.e. of the glassy phase of the tile, and/or of any glaze layers and adjusting said firing parameter on the basis of said determined values. In some embodiment, said determined value can be stored in a memory connected to the control unit, for example a personal computer, for controlling the kiln.

The kiln can comprise multiple temperature sensors, for example thermocouple, for measuring the temperature in the kiln in multiple points or sector of the kiln, so to that the temperature of the tile during its advancement in the kiln can be monitored. Preferably, said temperature sensors can be connected to the control unit that controls the kiln so that the adjustment of the cooling rate can be commanded only where it can be most effective, for example where the temperature is in proximity of the glass transition temperature of the glassy phase. In this way, for example only certain cooling means of the kiln can be controlled, i.e. those located in the portion of the kiln where the temperature is close the glass transition temperature of the kiln.

A second independent aspect of the invention relates to a system for carrying on the method of the first aspect. In particular, said second aspect provides for a system for manufacturing ceramic tiles comprising: a kiln configured for fire green ceramic tile according to a firing cycle defined by one or more firing parameters to obtain a ceramic tile, said kiln comprising one or more means for controlling said firing parameters; a device for measuring a shape and/or dimension parameter of the ceramic tile; a control unit connected to the device and to the kiln and configure to control said means on the basis of the measured value.

Said kiln preferably is a continuous kiln having a inlet opening and an exit opening. Said kiln can be a roller kiln. Rollers have the advantage that the tiles run on the rollers in form of one layer so that heat exchange at the upper and lower surface of the tile is optimized.

Said devices for controlling the parameters can comprise burners, blowers for hot hair, fresh air flow valves, engine for rotating the rollers etc.

Said device for measuring the shape and/or dimension parameter can comprise optical sensor. For example, said device is a device configured to measure a planarity deviation of the ceramic tile. Said device can be for example a laser gauges for applications on industrial processing lines.

With the intention of better showing the characteristics of the invention, in the following, as an example without any limitative character, several preferred forms of embodiments are described with reference to the accompanying drawings, wherein:

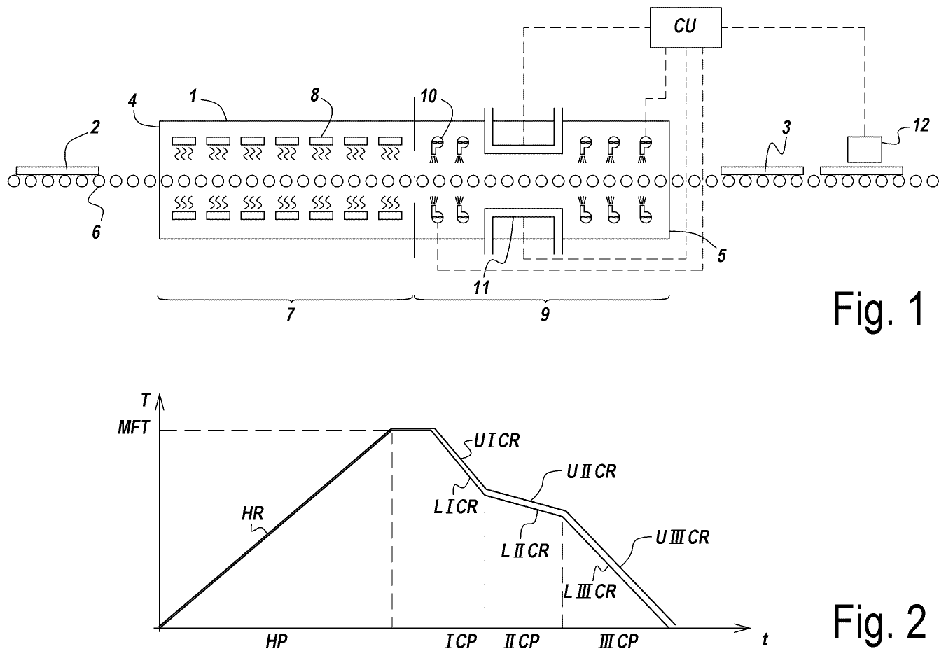

FIG. 1 schematically shows some step of a method according to the invention, and a system for carrying on the invention;

FIG. 2 shows a firing cycle for ceramic tile according to the invention;

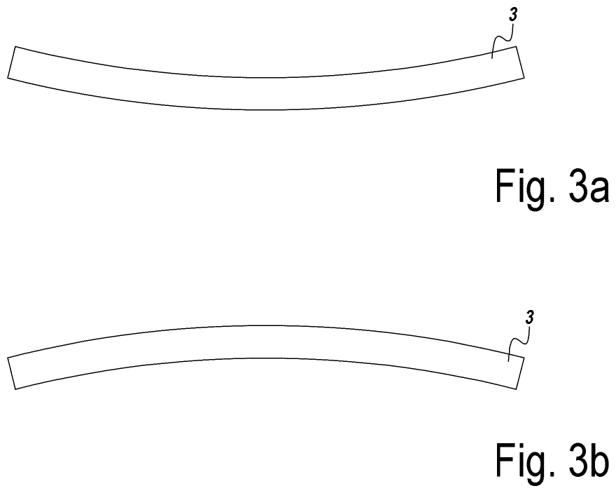

FIGS. 3a and 3b show a schematic side view respectively of a concave and of a convex tile.

FIG. 1 shows a roller kiln 1 for firing a green tile 2 to obtain a ceramic tile 3. The kiln 1 has an inlet opening 4 and an exit opening 5.

The green tile 2 has an upper and a lower surface. The green tile comprising at least a support made of a mixture of ceramic raw materials like, for example clays, kaolin, feldspar, calcium carbonate, zirconium silicate, talc, quartz and frits. The ceramic mixture forming the support of the green tile is configured for forming a glassy phase in the support of the ceramic tile 3. In the example said mixture is a mixture for porcelain tiles or slabs for floor, wall or furniture, and is configured for forming a glassy phase of for example between 50 and 70% based on the total weight of the support. The green tile 2, and consequently the ceramic tile 3, can comprise one or more glaze layers covering the upper surface of the support. It is noted that within the context of the present invention with ceramic tile 3 it is meant a ceramic tile after completion of the firing process in the kiln 1 and thus the expression ceramic tile it is used to refer to a tile after the exit from the kiln 1, whereas the expression green tile is used before and inside the kiln 1.

The kiln 1 comprises a plurality of motorized rollers 6 for advancing the green tile 2 from the inlet opening 4 toward the exit opening 5, the rollers supporting the lower surface of the green tile 2.

The kiln 1 comprises a heating portion 7 closer to the inlet opening 4 provided with burners 8 disposed above and below said rollers. Downstream to said heating portion 7, the kiln 1 is provided with a cooling portion 9 until the exit opening 5. Said cooling portion 9 is provided by first cooling means 10, for example air blowers or fans connected to tubes provided with ejecting nozzles or orifices, for direct cooling of the fired tile 2. In particular, the first cooling means are adapted to blow or convey a flow of air directly in contact with the tile. Preferably, said first cooling means 10 are disposed above and/or below said rollers 6 in such a way to blow fresh air on the upper and lower surface of the tile respectively. Said cooling part 9 is also provided by second cooling means 11 for indirect cooling of the green tile 2. In particular, the second cooling means comprise closed tubes for the flow of fresh air in the cooling portion for receiving heat from the tile. Preferably, said second cooling means 11 are disposed above and/or below said rollers 6. It is noted that within the context of the present invention with “fresh air” it is meant air that is colder than the tile, and that it can be used to cool the tile.

FIG. 1 further shows a device 12 configured to measure a shape and/or dimension parameter of the tile 3. The device 12 is disposed downstream the exit 5 of the kiln 1. In the preferred embodiment said device 12 comprises an optical sensor adapted to determine a planarity deviation of the ceramic tile 3. For example, the device 12 is laser gauges for applications on industrial processing lines.

The device 12 is connected to a control unit CU, for example a computer, that is connected to the first and/or the second cooling means 10, 11 for controlling them.

FIG. 2 schematically a possible firing cycle for firing ceramic tiles 3 using the kiln 1 shown in FIG. 1. In particular, FIG. 2 shows two firing cycles slightly different each other and active respectively on the upper surface and on the lower surface of the fired tile 2.

FIG. 2 shows that the firing cycle comprises a heating part HP wherein the temperature T of the green tile 2 increases with a substantially constant heating rate HR up to a maximum firing temperature MFT. Said heating rate being for example comprised between 80 and 150° C./min. FIG. 2 shows that heating rate can be slightly different on the upper surface of the tile and on the lower surface and that the heating part comprises an upper heating rate UHR and a lower heating rate LHR.

FIG. 2 shows that the maximum firing temperature can be maintained substantially constant for a predetermined interval. The maximum firing temperature MFT is preferably above 1000° C., for example for porcelain tiles, being between 1200° C. and 1270° C.

FIG. 2 shows that the firing cycle comprises a first cooling part ICP where the temperature T of the fired tile 2 decreases with a substantially constant first cooling rate ICR from the maximum firing temperature MFT down to a first end temperature, preferably between 750° C. and 850° C., said first end temperature being preferably in a range of between 50° C. more and 50° C. less than the glass transition temperature TG of the glassy phase of the ceramic tile 3. Said first cooling rate being for example comprised between 120 and 150° C./min. FIG. 2 shows that first cooling rate can be slightly different on the upper surface of the tile and on the lower surface and that the first cooling part comprises an upper first cooling rate UICR and a lower first heating rate LICR. Preferably during said first cooling part ICP the fired tile 2 is cooled via the direct cooling through the first cooling means 10.

FIG. 2 shows that the firing cycle comprises a second cooling part IICP where the temperature T of the fired tile 2 decreases with a substantially constant second cooling rate IICR from the first end temperature down to a second end temperature, preferably below 570° C. Said second cooling rate is lower than the first cooling rate, for example is between 100 and 80° C./min. FIG. 2 shows that second cooling rate can be slightly different on the upper surface of the tile and on the lower surface and that the second cooling part comprises an upper second cooling rate UIICR and a lower second heating rate LIICR. Preferably during said second cooling part IICP the fired tile 2 is cooled via the indirect cooling through the second cooling means 11.

FIG. 2 shows that the firing cycle comprises a third cooling part IIICP where the temperature T of the fired tile 2 decreases with a substantially constant third cooling rate IIICR from the second end temperature down to a final temperature, preferably around 100° C. Said third cooling rate is higher than the second cooling rate, for example is between 120 and 150° C./min. FIG. 2 shows that third cooling rate can be slightly different on the upper surface of the tile and on the lower surface and that the second cooling part comprises an upper third cooling rate UIIICR and a lower third heating rate LIIICR. Preferably during said third cooling part IIICP the fired tile 2 is cooled via the direct cooling through the first cooling means 10.

FIG. 3a illustrates a concave tile 3 that shows a concavity directed upward; FIG. 3b illustrates a convex tile 3 that shows a concavity directed upward.

When the device 12 measures a planarity deviation PD corresponding to a concave tile 3, as shown in FIG. 3a, the control unit CU commands the first or second cooling means 10, 11 to increase the upper first cooling rate UICP and/or the upper second cooling rate UIICP. In the preferred embodiment, for example, the CPU commands the first cooling means 10 to increase the flow rate of fresh air directed towards the upper surface of the fired tile 2 in the first cooling part ICP of the cycle. Preferably the upper first cooling rate is increased in an adjustment area AA of the firing cycle where the adjustment of the cooling rate is more effective for correcting the planarity deviation, said adjustment area AA being close to the first end temperature, preferably between 50° C. more and 50° C. less than the glass transition temperature TG of the glassy phase of the ceramic tile 3.

When the device 12 measures a planarity deviation PD corresponding to a convex tile 3, as shown in FIG. 3b, the control unit CU commands the first or second cooling means 10, 11 to increase the lower first cooling rate LICR and/or the lower second cooling rate LIICR. In the preferred embodiment, for example, the CPU commands the first cooling means 10 to increase the flow rate of fresh air directed towards the lower surface of the green tile 2 in the first cooling part ICP of the cycle. Preferably the lower first cooling rate LICR is increased in an adjustment area AA of the firing cycle where the adjustment of the cooling rate is more effective for correcting the planarity deviation, said adjustment area AA being close to the first end temperature, preferably between 50° C. more and 50° C. less than the glass transition temperature TG of the glassy phase of the ceramic tile 3.

The method of the invention can also comprise the step of manufacturing a sample od mixture of raw material for forming the green tile 2 and measuring the glass transition temperature TG of the glassy phase formed by said mixture. Said sample can be manufactured and tested in a laboratory. The method subsequently, can comprise storing the measured value of glass transition temperature TG in a memory unit of said control unit CU, so that the control unit CU can adjust the cooling rate on the basis of said glass transition temperature TG and of said measured planarity deviation PD.

The present invention is in no way limited to the hereinabove described embodiments, but such equipment and/or plant may be realized according to different variants without leaving the scope of the present invention.

Further, as is clear from the content of the description, the present invention relates to one or more of the items as listed below, numbered from 1 to 21:
1.—A method for manufacturing ceramic tiles that comprises the steps of providing a green tile formed by a mixture of ceramic raw materials, firing said green tile in a kiln to obtain a ceramic tile, said kiln being configured to fire the green tile according to a firing cycle defined by one or more firing parameter, wherein it comprises the steps of measuring a shape and/or dimension parameter of the obtained ceramic tile, and the step of adjusting the firing parameter on the basis of said measurement, preferably while one parameter is adjustable, the remaining parameters can be kept constant (are not adjusted).
2.—The method according to item 1, wherein said firing parameters can comprise maximum temperature, heating rate, cooling rate, firing time.
3.—The method according to item 1 or 2, wherein said firing cycle comprises an upper firing cycle, acting on an upper surface of the tile, and a lower firing cycle, having respective upper and lower firing parameter, wherein said adjustable firing parameters can be both or only one of the upper and lower correspondent firing parameters, for example upper and lower cooling rate.
4.—The method according to any of the preceding items, wherein firing cycle comprises:
   a first cooling part, preferably starting from the maximum temperature of the firing cycle, for example above 900° C., preferably between 900° C. and 1250° C., and ends at a temperature around 800° C., for example between 750°° C. and 850° C., or ends at a temperature being 50° C. more or 50° C. less than the glass transition temperature of the ceramic tile, said first cooling part having a respective first cooling rate; and/or
   a second cooling part that starts from the end of the first cooling part and ends at a temperature around 570° C., in particular said end temperature of the second period substantially corresponds to the transition temperature between β-quartz and α-quartz, said second cooling part having a second cooling rate; and/or
   a third cooling part starting from the end of the second cooling part and ends at the exit of the kiln, for example at a temperature around 150° C., said third cooling part having a third cooling rate.
5.—The method according to any of the preceding items, wherein the method comprises adjusting a cooling rate of the tile in proximity of a glass transition temperature of the tile, preferably of a glassy phase thereof, for example between 50° C. above or 50° C. below said glass transition temperature.
6.—The method according to any of the preceding items, wherein said kiln is adapted to cool the tile via indirect cooling or via direct cooling, preferably wherein the method comprises adjusting the cooling rate in said direct or in said indirect cooling.
7—The method according to any of the preceding items, wherein the shape and/or dimension parameter can be preferably measured by a measuring device connected to a control unit. preferably said control unit can preferably be connected to the kiln for adjusting said firing parameter.
8.—The method according to item 7, wherein said measuring device comprises optical sensor.
9.—The method according to any of the preceding items, wherein said deformation is measured immediately at the exit of the kiln, or wherein said deformation is measured after a predetermined time after the exit of the tile from the kiln, said predetermined time preferably being at least 10 min, for example at least 20 min, and/or wherein said deformation can be measured when the temperature of the tile is below a predetermined threshold temperature, said threshold temperature preferably 150° C., for example below 100° C.
10.—The method according to any of the preceding items, wherein said the said deformation comprises the planarity deviation of the tile.
11.—The method according to items 10 and 3, wherein in case the measured planarity deviation shows a convex tile, said deviation can be corrected by increasing a lower cooling rate or decreasing a upper cooling rate; and/or in case in case the measured planarity deviation shows a concave tile, said deviation can be corrected by decreasing a lower cooling rate or increasing a upper cooling rate.
12.—The method according to any of the preceding items, wherein the tile comprises a support made of a ceramic material, for example p, red body tile, earthenware, single fire wall tile, preferably porcelain.
13.—The method according to any of the preceding items, wherein the tile comprises a top layer comprising one or more glaze layers.
14.—The method according to any of the preceding items, wherein the obtained fired tile, comprises a support having a glassy phase, preferably wherein said glassy phase represents up to the 80%, for example between 50 and 75% based on the total weight of the support.
15.—The method according to item 14, comprising the step of determining the glass transition temperature of the mixture of raw materials of the green tile, i.e. of the glassy phase of the tile, and/or of any glaze layers and adjusting said firing parameter on the basis of said determined values.
16.—The method according to item 15, wherein said determined value can be stored in a memory connected to the control unit, for example a personal computer, for controlling the kiln.
17.—The method according to any of the preceding items, wherein the kiln comprises multiple temperature sensors, for example thermocouple, for measuring the temperature in the kiln in multiple points or sector of the kiln itself, preferably, said temperature sensors can be connected to the control unit that controls the kiln so that the adjustment of the cooling rate can be commanded only where it can be most effective, for example where the temperature is in proximity of the glass transition temperature of the glassy phase.
18.—A system for manufacturing ceramic tiles, preferably according to a method as per any of the preceding items, comprising:
   a kiln configured for fire green ceramic tile according to a firing cycle defined by one or more firing parameters to obtain a ceramic tile, said kiln comprising one or more means for controlling said firing parameters;
   a device for measuring a shape and/or dimension parameter of the ceramic tile;
   a control unit connected to the device and to the kiln and configure to control said means on the basis of the measured value.
19—The system of item 18, wherein said kiln is a continuous kiln having a inlet opening and an exit opening, preferably a roller kiln.
20—The system of item 18 or 19, wherein said means for controlling the parameters can comprise burners, blowers for hot hair, fresh air flow valves, engine for rotating the rollers etc.
21—The system of the items from 18 or 20, wherein said device for measuring the shape and/or dimension parameter can comprise optical sensor, for example, said device is a device configured to measure a planarity deviation of the ceramic tile.

1.-20. (canceled)

21. A method for manufacturing ceramic tiles that comprises the steps of providing a green tile formed by a mixture of ceramic raw materials, firing said green tile in a kiln to obtain a ceramic tile, said kiln being configured to fire the green tile according to a firing cycle defined by one or more firing parameter, wherein the method comprises the steps of measuring a shape and/or dimension parameter of the obtained ceramic tile, and the step of adjusting the firing parameter on the basis of said measurement, preferably while one parameter is adjustable the remaining parameters are be kept constant.

22. The method according to claim 21, wherein said firing parameters can comprise maximum temperature, heating rate, cooling rate, firing time.

23. The method according to claim 21, wherein said firing cycle comprises an upper firing cycle, acting on an upper surface of the tile, and a lower firing cycle, having respective upper and lower firing parameter, wherein said adjustable firing parameters comprise at least one of the upper and lower correspondent firing parameters, preferably upper cooling rate and lower cooling rate.

24. The method according to claim 21, wherein the firing cycle comprises:
a first cooling part, preferably starting from the maximum temperature of the firing cycle, and ending at a temperature around 800° C., for example between 750° C. and 850° C., or ending at a temperature being 50° C. more or 50° C. less than a glass transition temperature of the ceramic tile, or of a glassy phase thereof, said first cooling part having a respective first cooling rate; and/or
a second cooling part that starts from the end of the first cooling part and ends at a temperature around 570° C., said second cooling part having a second cooling rate; and/or
a third cooling part starting from the end of the second cooling part and ending at the exit of the kiln, said third cooling part having a third cooling rate.

25. The method according to claim 21, wherein the method comprises adjusting a cooling rate in the kiln in proximity of a glass transition temperature of the tile, preferably of a glassy phase thereof, for example between 50° C. above or 50° C. below said glass transition temperature.

26. The method according to claim 21, wherein said kiln is adapted to cool the tile via indirect cooling and/or via direct cooling, and wherein the method comprises adjusting the cooling rate in said direct cooling.

27. The method according to claim 21, wherein the shape and/or dimension parameter can be preferably measured by a measuring device connected to a control unit, preferably said control unit being connected to the kiln for adjusting said firing parameter.

28. The method according to claim 27, wherein said measuring device comprises an optical sensor.

29. The method according to claim 21, wherein said deformation is measured:
immediately at the exit of the kiln; or
after a predetermined time after the exit of the tile from the kiln, said predetermined time preferably being at least 10 min, for example at least 20 min; and/or
when the temperature of the tile is below a predetermined threshold temperature, preferably said threshold temperature being 150° C. or below, for example below 100° C.

30. The method according to claim 21, wherein said the said deformation comprises the planarity deviation of the tile.

31. The method according to claims 30, wherein in case the measured planarity deviation shows a convex tile, said deviation can be corrected by increasing a lower cooling rate or decreasing a upper cooling rate (UICR, UIICR); and/or in case in case the measured planarity deviation shows a concave tile, said deviation can be corrected by decreasing a lower cooling rate or increasing a upper cooling rate.

32. The method according to claim 21, wherein the tile comprises a support made of a ceramic material selected from the group comprising: red body tile, earthenware, single fire wall tile, porcelain.

33. The method according to claim 21, wherein the tile comprises a top layer comprising one or more glaze layers.

34. The method according to claim 21, wherein the obtained fired tile comprises a support having a glassy phase, preferably wherein said glassy phase represents up to the 80%, for example between 50 and 75% based on the total weight of the support.

35. The method according to claim 21, wherein it comprises the step of determining the glass transition temperature of the mixture of raw materials of the green tile, i.e. of the glassy phase of the tile, and/or of any glaze layers and adjusting said firing parameter on the basis of said determined values.

36. The method according to claim 35, wherein said determined value can be stored in a memory connected to the control unit, for example a personal computer, for controlling the kiln.

37. The method according to claim 21, wherein the kiln comprises multiple temperature sensors, for example thermocouple, for measuring the temperature in the kiln in multiple points or sector of the kiln itself, preferably, said temperature sensors can be connected to the control unit that controls the kiln so that the adjustment of the cooling rate can be commanded only where it can be most effective, for example where the temperature is in proximity of the glass transition temperature of the glassy phase.

38.-(New) A system for manufacturing ceramic tiles, the method comprising:
a kiln configured for fire green ceramic tile according to a firing cycle defined by one or more firing parameters to obtain a ceramic tile, said kiln comprising one or more devices for controlling said firing parameters;
a device for measuring a shape and/or dimension parameter of the ceramic tile;
a control unit connected to the measuring device and to the kiln and configured to control said devices of the kiln on the basis of the measured value.

39. The system of claim 38, wherein said kiln is a continuous kiln having an inlet opening and an exit opening, preferably a roller kiln.

40. The system of claim 38, wherein said means for controlling the parameters can comprise burners, blowers for hot hair, fresh air flow valves and/or engine for rotating the rollers.
